(19) United States
(12) Patent Application Publication
(10) Pub. No.: US 2024/0359268 A1
(43) Pub. Date: Oct. 31, 2024

(54) METHOD FOR PRODUCING ELECTRICITY STORAGE DEVICE

(71) Applicant: Prime Planet Energy & Solutions, Inc., Tokyo (JP)

(72) Inventor: Yasuyuki SAITO, Kakogawa-shi (JP)

(21) Appl. No.: 18/638,676

(22) Filed: Apr. 18, 2024

(30) Foreign Application Priority Data
Apr. 28, 2023 (JP) 2023-073900

(51) Int. Cl. B23K 26/57; B23K 26/082; B23K 101/38; H01M 10/0587

(52) U.S. Cl. CPC B23K 26/57; B23K 26/082; H01M 10/0587; B23K 2101/38

(57) ABSTRACT

The method disclosed here is a method for producing an electricity storage device including positive and negative electrodes, and includes overlaying a plurality of laminated layers of current collecting foil and a current collector in at least one of the positive electrode or the negative electrode. The method also includes placing a laser light transmissive member on the layers of current collecting foil overlying the current collector such that a portion of the laser light transmissive member extends off from an end portion of the layers of the current collecting foil overlying the current collector. The method further includes applying laser light to a region including the end portion of the layers of the current collecting foil overlying the current collector through the laser light transmissive member to perform welding of the layers of the current collecting foil overlying the current collector and the current collector.

### TECHNICAL FIELD

The present disclosure relates to a method for producing an electricity storage device. This application claims the benefit of priority to Japanese Patent Application No. 2023-073900 filed on Apr. 28, 2023. The entire contents of this application are hereby incorporated herein by reference.

### BACKGROUND ART

Resistance welding or ultrasonic welding has been conventionally widely used for joining a plurality of current collecting foil layers and a current collector in each electrode of an electrode body. On the other hand, from the viewpoint of cost reduction, techniques for joining current collecting foil layers and a current collector by laser welding have been developed. Patent Document 1, for example, discloses a laser welding technique including temporary joint in order to enhance adhesion of metal foil. Patent Documents 2 through 4 disclose techniques in which laser welding is performed while pressing a peripheral portion of a region to be subjected to laser welding in metal foil with a jig.

### CITATION LIST

### Patent Documents

Patent Document 1: Japanese Patent Application Publication No. 2014-140890
Patent Document 2: Japanese Patent Application Publication No. 2014-136242
Patent Document 3: Japanese Patent Application Publication No. 2016-030280
Patent Document 4: Japanese Patent Application Publication No. 2019-067570

### SUMMARY

In the case of laser welding of laminated current collecting foil layers and a current collector, recesses might be formed mainly on a portion exposed to laser light. These recesses might reach the boundary between the current collecting foil and the current collector, and in this case, a joint width where the current collector and the current collecting foil layers are joined decreases.

Embodiments of the present disclosure provide a technique for enhancing joinability between current collecting foil and a current collector.

Embodiments of the present disclosure provide a method for producing an electricity storage device including: a positive electrode including a plurality of laminated layers of positive electrode current collecting foil and a positive electrode current collector connected to the laminated layers of the positive electrode current collecting foil, and a negative electrode including a plurality of laminated layers of negative electrode current collecting foil and a negative electrode current collector connected to the laminated layers of the negative electrode current collecting foil. An aspect of the production method disclosed here includes overlaying the laminated layers of the current collecting foil on the current collector in at least one of the positive electrode or the negative electrode. The production method also includes placing a laser light transmissive member on the layers of the current collecting foil overlying the current collector such that a portion of the laser light transmissive member extends off from an end portion of the layers of the current collecting foil overlying the current collector. The production method also includes applying laser light to a region including the end portion of the layers of the current collecting foil overlying the current collector through the laser light transmissive member to perform welding of the layers of the current collecting foil overlying the current collector and the current collector.

Through a study of an inventor of the present disclosure, it has been found that in the case of laser welding of a plurality of laminated layers of current collecting foil and a current collector, one reason for occurrence of a recess on a portion exposed to laser light is that metal vapor generated in the portion exposed to laser light remains in the same area. With the production method described above, since laser light is applied to a region including an end portion of the layers of the current collecting foil overlying the current collector, metal vapor generated by laser welding does not remain in the portion exposed to laser light L and can be diffused (released) to adjacent space. Accordingly, it is possible to reduce a loss of a weld width (joint section) of a laser welded portion formed across the layers of the current collecting foil and the current collector.

### BRIEF DESCRIPTION OF THE DRAWINGS

FIG. 1 is a schematic cross-sectional view generally illustrating a configuration of a nonaqueous electrolyte secondary battery according to one embodiment.

FIG. 2 is a disassembled view schematically illustrating a configuration of an electrode body of a nonaqueous electrolyte secondary battery according to one embodiment.

FIG. 3 is a schematic view illustrating a laser welding method according to one embodiment.

FIG. 4 is a schematic view illustrating a cross section near a laser welded portion according to one embodiment.

FIG. 5 is a schematic view illustrating a laser welding method according to a variation.

FIG. 6 is a cross-sectional SEM image near a laser welded portion in Example 1.

FIG. 7 is a cross-sectional SEM image near a laser welded portion in Example 2.

FIG. 8 is a cross-sectional SEM image near a laser welded portion of a comparative example.

### DETAILED DESCRIPTION

The technique disclosed here will be described in detail. Matter other than matter specifically mentioned herein (e.g., laser welding method for layers of current collecting foil and a current collector) but required for carrying out the technique disclosed here (e.g., method for assembling an electricity storage device) can be understood as design matter of those skilled in the art based on the prior art in the field. The technique disclosed here can be carried out on the basis of the contents disclosed in the description and common general technical knowledge in the field.

The drawings are schematically illustrated, and dimensional relationship (e.g., length, width, and thickness) in the drawings do not necessarily reflect actual dimensional relationships. In the drawings to be described below, members and parts having the same functions are denoted by the same reference characters, and duplicate explanation will be omitted or will be simplified.

In this specification, when a numerical range is stated as “A to B (where A and B are any values), this numerical range means “A or more and B or less,” as well as “more than A and less than B,” “more than A and B or less,” and “A or more and less than B.”

An “electricity storage device” herein refers to a device that can be charged and discharged. The electricity storage device includes batteries such as a primary battery and a secondary battery (e.g., lithium ion secondary battery or nickel hydrogen battery), and a capacitor (physical cell) such as an electric double layer capacitor. The following description is directed to a nonaqueous electrolyte secondary battery that is one embodiment of an electricity storage device produced by the production method disclosed here. It should be noted that the electricity storage device produced by the technique disclosed here is not limited to a nonaqueous electrolyte secondary battery.

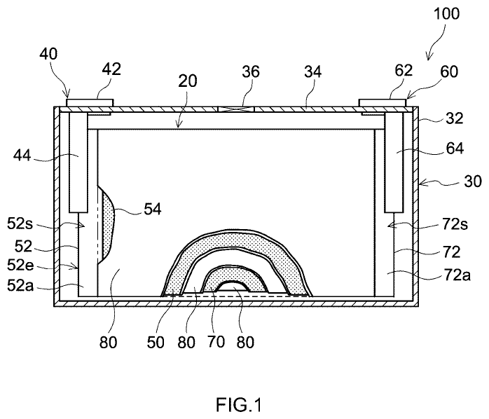

FIG. 1 is a schematic cross-sectional view generally illustrating a configuration of a nonaqueous electrolyte secondary battery 100 according to one embodiment. The nonaqueous electrolyte secondary battery 100 includes an electrode body 20, a case 30, a positive electrode 40, a negative electrode 60, and a nonaqueous electrolyte (not shown). The positive electrode 40 includes a positive electrode terminal 42, a positive electrode current collector 44, and a positive electrode plate 50. The negative electrode 60 includes a negative electrode terminal 62, a negative electrode current collector 64, and a negative electrode plate 70. Although not particularly limited, in this embodiment, the nonaqueous electrolyte secondary battery 100 is a lithium ion secondary battery.

As illustrated in FIG. 1, the nonaqueous electrolyte secondary battery 100 is a square sealed battery in which the case 30 houses a flat electrode body (wound electrode body) 20 and a nonaqueous electrolyte (not shown). The case 30 includes a case body 32 having an opening, and a sealing member 34 that seals the opening. The sealing member 34 has a plate shape in this embodiment. The sealing member 34 includes a positive electrode terminal 42 and a negative electrode terminal 62 for external connection. The sealing member 34 includes a thin safety valve 36 configured to release an internal pressure of the case 30 when the internal pressure of the case 30 increases to a predetermined level or more. The case 30 also includes an injection port (not shown) for injecting a nonaqueous electrolyte. A material for the case 30 is desirably a lightweight metal material having high strength and high thermal conductivity. Examples of the metal material include aluminum and steel.

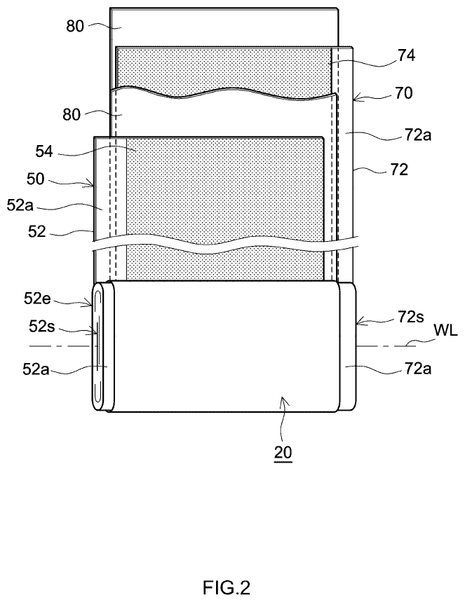

FIG. 2 is a disassembled view schematically illustrating a configuration of the electrode body 20 of the nonaqueous electrolyte secondary battery 100 according to one embodiment. In FIG. 2, the electrode body 20 is a wound electrode body in which a long sheet-like positive electrode plate 50 and a long sheet-like negative electrode plate 70 are stacked with two long sheet-like separators 80 interposed therebetween such that the longitudinal directions of the positive and negative electrode plates 50 and 70 coincide with each other, and they are wound around a winding axis WL in the longitudinal direction. The positive electrode plate 50 includes positive electrode current collecting foil 52 and a positive electrode active material layer 54 disposed in the longitudinal direction on one or each surface of the positive electrode current collecting foil 52. One end of the positive electrode current collecting foil 52 in the direction of the winding axis WL (i.e., a sheet width direction orthogonal to the longitudinal direction) has a portion where no positive electrode active material layer 54 is formed in a band shape along the end portion and the positive electrode current collecting foil 52 is exposed (i.e., positive electrode current collecting foil exposed portion 52a). The negative electrode plate 70 includes negative electrode current collecting foil 72 and a negative electrode active material layer 74 disposed in the longitudinal direction on one or each surface of the negative electrode current collecting foil 72. The other end of the negative electrode current collecting foil 72 in the winding axis WL (i.e., the end opposite to the positive electrode current collecting foil exposed portions 52a) has a portion where no negative electrode active material layer 74 is formed in a band shape along the end portion and the negative electrode current collecting foil 72 is exposed (i.e., negative electrode current collecting foil exposed portion 72a).

The electrode body 20 includes a laminated portion 52s in which a plurality of layers of the positive electrode current collecting foil exposed portion 52a are laminated in the thickness direction of the electrode body 20. The laminated portion 52s is formed by, for example, winding the positive electrode current collecting foil 52. A portion of the laminated portion 52s is joined to the positive electrode current collector 44 by laser welding. That is, the laminated portion 52s and the positive electrode current collector 44 are connected (joined) through a laser welded portion. The laser welded portion is, for example, disposed in an end portion 52e of the laminated portion 52s (left end portion of the electrode body 20 in FIG. 1). The laser welded portion will be described later (see laser welded portion 90 in FIG. 4 described later). The number of layers of the positive electrode current collecting foil 52 (positive electrode current collecting foil exposed portion 52a) in the laminated portion 52s can be, for example, about 10 to 120 or about 20 to 100. The negative electrode current collecting foil 72 include a laminated portion 72s in which a plurality of layers of the negative electrode current collecting foil exposed portion 72a are laminated in the thickness direction of the electrode body 20. A portion of the laminated portion 72s is joined to the negative electrode current collector 64 by laser welding, for example. That is, the laminated portion 72s and the negative electrode current collector 64 may be connected (joined) through a laser welded portion. The number of layers of the negative electrode current collecting foil 72 (negative electrode current collecting foil exposed portion 72a) in the laminated portion 72s can be, for example, about 10 to 120 or about 20 to 100. The current collecting foil and the current collector in the negative electrode 60 may be joined in a manner the same as or different from that in the positive electrode 40. For example, the joint portion between the current collecting foil and the current collector in the negative electrode 60 may be an ultrasonic joint portion, a resistance welded portion, or the like.

It should be noted that the positive electrode current collecting foil 52 may have tabs extending from an end of the positive electrode current collecting foil 52 in the lateral direction. The shape of the tabs is not particularly limited, and can be, for example, a trapezoid or a rectangle in plane view. The tabs include the positive electrode current collecting foil exposed portion 52a, for example. In this case, the electrode body 20 includes the laminated portion 52s in which a plurality of tabs are provided. The negative electrode current collecting foil 72 may also include tabs. The configuration of the tabs may be the same as or similar to that of the positive electrode current collecting foil 52 described above.

The positive electrode current collector 44 includes a portion that is to be a laser welded portion by being joined to the positive electrode current collecting foil exposed portion 52a and that desirably has a plate shape. The whole of the positive electrode current collector 44 may have a plate shape. The thickness of a portion of the positive electrode current collector 44 to be joined to the positive electrode current collecting foil exposed portion 52a can be, for example, 0.5 mm to 3 mm. The negative electrode current collector 64 includes a portion that is to be a laser welded portion by being joined to the negative electrode current collecting foil exposed portion 72a and that desirably has a plate shape. The whole of the negative electrode current collector 64 may have a plate shape. The thickness of a portion of the negative electrode current collector 64 to be joined to the negative electrode current collecting foil exposed portion 72a can be, for example, 0.5 mm to 3 mm.

An insulating member (not shown) for insulating the positive electrode terminal 42 and the sealing member 34 from each other can be disposed between the positive electrode terminal 42 and the sealing member 34. The insulating member can be made of, for example, a resin member having electrical insulation. Examples of the resin include polyolefin resins such as polypropylene (PP), fluorinated resins such as perfluoroalkoxyethylene copolymer (PFA) and polytetrafluoroethylene (PTFE), and polyphenylene sulfide (PPS). The insulating member may also be disposed between the negative electrode terminal 62 and the sealing member 34, between the positive electrode current collector 44 and the sealing member 34, and/or between the negative electrode current collector 64 and the sealing member 34.

Examples of the positive electrode current collecting foil 52 include aluminum foil. The thickness of the positive electrode current collecting foil 52 can be, for example, 5 to 20 μm. The positive electrode active material layer 54 includes a positive electrode active material. The positive electrode active material may be a known positive electrode active material used for lithium ion secondary batteries, and examples of the positive electrode active material include a lithium-metal composite oxide having a layered structure, a spinel structure, or an olivine structure (e.g., LiNi_{1/3}Co_{1/3}Mn_{1/3}O₂, LiNiO₂, LiCoO₂, LiFeO₂, LiMn₂O₄, LiNi_{0.5}Mn_{1.5}O₄, LiCrMnO₄, and LiFePO₄). The positive electrode active material layer 54 may include a conductive material and/or a binder, for example. Desired examples of the conductive material include carbon black such as acetylene black (AB) and other carbon materials (e.g., graphite). Examples of the binder include polyvinylidene fluoride (PVDF). The positive electrode active material layer 54 can be formed by dispersing a positive electrode active material and optional materials (e.g., a conductive material, a binder, etc.) in an appropriate solvent (e.g., N-methyl-2-pyrrolidone: NMP) to prepare a composition in a paste form (or slurry form) (positive electrode material mixture paste), applying an appropriate amount of the composition onto the surface of the positive electrode current collecting foil 52, and drying the composition.

Examples of the negative electrode current collecting foil 72 include copper foil. The thickness of the negative electrode current collecting foil 72 can be, for example, 5 to 20 μm. The negative electrode active material layer 74 includes a negative electrode active material. Examples of the negative electrode active material include carbon materials such as graphite, hard carbon, and soft carbon. The negative electrode active material layer 74 may further include a binder, a thickener, and other materials. Examples of the binder include styrene-butadiene rubber (SBR). Examples of the thickener includes carboxymethyl cellulose (CMC). The negative electrode active material layer 74 can be formed by, for example, dispersing a negative electrode active material and optional materials (such as a binder) in an appropriate solvent (e.g., ion-exchanged water) to preparing a composition in a paste form (or slurry form), applying an appropriate amount of the composition onto the surface of the negative electrode current collecting foil 72, and drying the composition.

As the separators 80, various types of microporous sheets the same as or similar to those conventionally used can be used, and examples of the separators 80 include microporous resin sheets of resins such as polyethylene (PE) and polypropylene (PP). The microporous resin sheet may have a single-layer structure or a multi-layer structure with two or more layers (e.g., three-layer structure in which PP layers are stacked on both surfaces of a PE layer). The separator 80 may include a heat-resistant layer (HRL).

The nonaqueous electrolyte can be of a type the same as or similar to those used for a conventional nonaqueous electrolyte, and is, for example, a nonaqueous electrolyte in which a supporting electrolyte is included in an organic solvent (nonaqueous solvent). Examples of the nonaqueous solvent include aprotic solvents such as carbonates, esters, and ethers. Among these solvents, carbonates, such as ethylene carbonate (EC), diethyl carbonate (DEC), dimethyl carbonate (DMC), and ethyl methyl carbonate (EMC), can be desirably employed.

Alternatively, fluorine-based solvents such as fluorinated carbonate exemplified by monofluoroethylene carbonate (MFEC), difluoroethylene carbonate (DFEC), monofluoromethyl difluoromethyl carbonate (F-DMC), trifluorodimethyl carbonate (TFDMC) are desirably used. Such nonaqueous solvents may be used alone or two or more of them may be used in combination. The supporting electrolyte is desirably lithium salts such as LiPF₆, LiBF₄, and LiClO₄. Although not particularly limited, the concentration of the supporting electrolyte is desirably about 0.7 mol/L or more and about 1.3 mol/L or less. The nonaqueous electrolyte may include components other than the nonaqueous electrolyte and the supporting electrolyte described above, and thus, can include additives such as a gas generating agent, a film forming agent, a disperser, and a thickener, as long as effects of the technique disclosed here are not significantly impaired.

The electricity storage device such as the nonaqueous electrolyte secondary battery 100 can be used for various applications, and suitably used as a power source (drive power source) for motors mounted on vehicles such as automobiles and trucks. Although not particularly limited, examples of the type of the vehicle include a plug-in hybrid electric vehicle (PHEV), a hybrid electric vehicle (HEV), and a battery electric vehicle (BEV).

The shape of the electricity storage device disclosed here is not limited to a square shape, and may be a coin shape, a button shape, or a cylindrical shape, for example. The electricity storage device may be configured as an electricity storage device including a laminated case. The electricity storage device disclosed here can be a polymer battery using a polymer electrolyte instead of a nonaqueous electrolyte or an all-solid-state battery using a solid electrolyte, for example.

A method for producing an electricity storage device disclosed here will now be described. The production method disclosed here includes, for example, an overlaying step of overlaying layers of current collecting foil, a current collector, and a laser light transmissive member in a positive electrode or a negative electrode, and a welding step of applying laser light to the layers of the current collecting foil through the laser light transmissive member to laser-weld the layers of the current collecting foil and the current collector. Besides the welding step, the production method disclosed here may include steps such as a preparation step, an assembly step, a housing step, a sealing step, and an injection step as necessary in any order. One embodiment of the production method disclosed here will be described.

In the preparation step, an electrode body is prepared, for example. The electrode body may be a wound electrode body such as the electrode body 20 described above, or a stacked-type electrode body that is an electrode body in which a plurality of positive electrode plates and a plurality of negative electrode plates are alternately laminated with separators interposed therebetween. In this embodiment, description will be given using the electrode body 20 described above as an example. The electrode body 20 can be produced in a conventionally known procedure.

The overlaying step includes overlaying a plurality of laminated layers of current collecting foil (laminated layers of the current collecting foil exposed portion) and a current collector in at least one of the positive electrode 40 or the negative electrode 60, and placing a laser light transmissive member on the layers of the current collecting foil overlying the current collector. The following description will be given using the positive electrode 40 as an example.

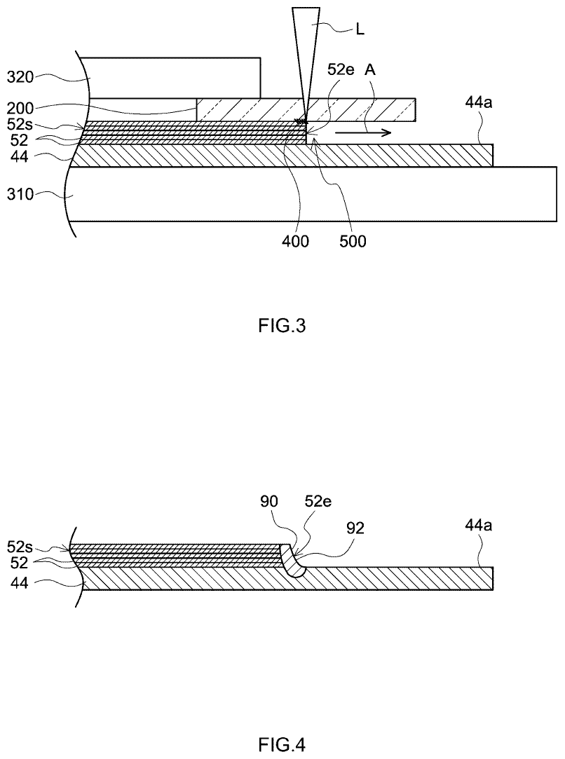

FIG. 3 is a schematic view illustrating a laser welding method according to one embodiment. FIG. 4 is a schematic view illustrating a cross section near a laser welded portion according to one embodiment. FIG. 4 can be a schematic view of a laser welded portion formed by the laser welding method shown in FIG. 3, for example. FIG. 4 is a view schematically illustrating a configuration near the laser welded portion 90 of the laminated portion 52s of the positive electrode current collecting foil 52 and the positive electrode current collector 44 in the nonaqueous electrolyte secondary battery 100.

As illustrated in FIG. 3, in this embodiment, a jig including a lower plate 310 and an upper plate 320 is used. Although not shown, the lower plate 310 and the upper plate 320 are configured such that the distance between the lower plate 310 and the upper plate 320 can be freely adjusted (or fixed).

In the overlaying step, first, the positive electrode current collector 44 is placed on the lower plate 310, for example. Next, the laminated portion 52s of the positive electrode current collecting foil 52 of the electrode body 20 is overlaid on a surface 44a of the positive electrode current collector 44. At this time, the end portion 52e of the laminated portion 52s in the direction of the winding axis WL of the electrode body 20 is located on the positive electrode current collector 44. In this example, in the end portion 52e of the laminated portion 52s, ends of each layer of the positive electrode current collecting foil 52 laminated in the laminated portion 52s are aligned along the lamination direction of the laminated portion 52s.

The laminated portion 52s includes a pre-welded portion 400. The pre-welded portion 400 is a region to which laser light L is applied in the welding step described later. In this embodiment, the pre-welded portion 400 includes a region including the end portion 52c of the laminated portion 52s. The pre-welded portion 400 is melted by application of laser light L. Accordingly, a laser welded portion where the laminated portion 52s and the positive electrode current collector 44 are joined is formed.

Then, the laser light transmissive member 200 is placed on top (the uppermost surface) of the laminated portion 52s. At this time, a portion of the laser light transmissive member 200 is placed so as to extend off from the end portion 52e of the laminated portion 52s. In other words, the laser light transmissive member 200 is placed such that the laminated portion 52s is sandwiched between a portion of the laser light transmissive member 200 and the positive electrode current collector 44. The laser light transmissive member 200 is placed so as to cover the pre-welded portion 400. According to this, the laser light transmissive member 200 directly presses the pre-welded portion 400 in the lamination direction of the laminated portion 52s. In this manner, gaps between the laminated layers of the positive electrode current collecting foil 52 can be reduced in the pre-welded portion 400. It should be noted that in placing the laser light transmissive member 200, the laser light transmissive member 200 is desirably placed after wrinkles of the pre-welded portion 400 of the positive electrode current collecting foil 52 are smoothed. According to this, gaps between the laminated layers of the foil in the laminated portion 52s decreases, and melt-cutting in laser welding is suppressed.

As illustrated in FIG. 3, space 500 through which metal vapor A generated from a portion exposed to laser light L can pass is formed between a portion of the laser light transmissive member 200 extending off from the end portion 52e of the laminated portion 52s and the positive electrode current collector 44 facing this portion of the laser light transmissive member 200. The metal vapor A is generated from, for example, the positive electrode current collecting foil 52 or the positive electrode current collector 44 melted by application of laser light L or heat transferred from the laser light L. It should be noted that the direction of the arrow of the metal vapor A in FIG. 3 indicates an example of the direction in which the metal vapor A is diffused. The space 500 is desirably space communicating from the end portion 52c of the laminated portion 52s to an end portion of the laser light transmissive member 200.

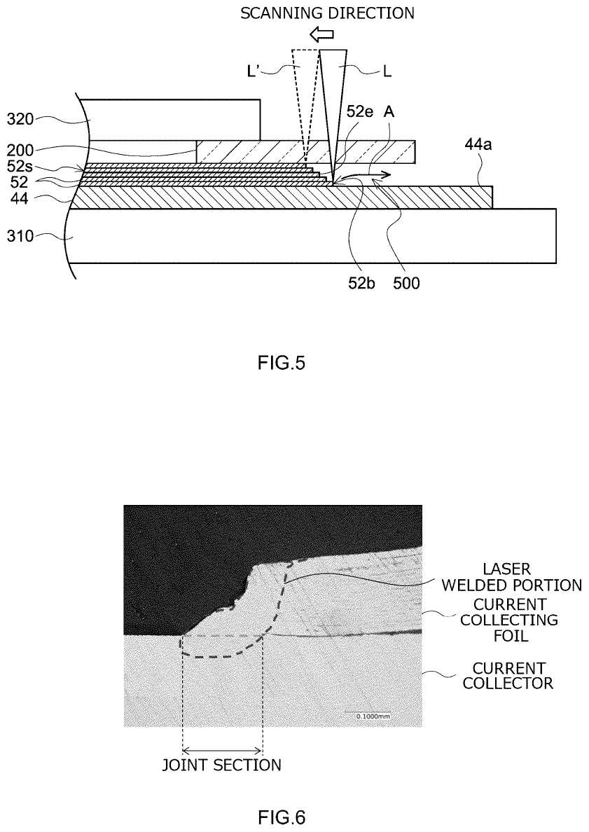

In this technique, the presence of the space 500 prevents the metal vapor A from remaining a portion exposed to laser light L, and allows the metal vapor A to be diffused (released) to the space 500. In this technique, since laser light L is applied to a region including the end portion 52e of the laminated portion 52s, the metal vapor A is generated in the end portion 52e of the laminated portion 52s, and thus, the metal vapor A is easily diffused to the space 500. A study of the inventor of the present disclosure has found that the metal vapor A is diffused (released) from a portion exposed to laser light L, so that a loss of a weld width (joint section) of the laser welded portion formed across the current collecting foil and the current collector can be reduced (see test examples below (e.g., FIGS. 6 through 8 described later)).

The shape of the laser light transmissive member 200 is not particularly limited, and is a plate shape in this embodiment. The laser light transmissive member 200 can be a circle, an oval, a rectangle, or a polygon in a plane view. Since the laser light transmissive member 200 has a plate shape, when the laser light transmissive member 200 is pressed toward the positive electrode current collector 44, the positive electrode current collecting foil 52 sandwiched between the laser light transmissive member 200 and the positive electrode current collector 44 can be pushed with a more uniform force, and thus, gaps between the layers of the foil can be more uniformly reduced. It should be noted that the laser light transmissive member 200 may have any size as long as the laser light transmissive member 200 can cover the pre-welded portion 400 of the laminated portion 52s (positive electrode current collecting foil 52).

Thereafter, the upper plate 320 is placed on the laser light transmissive member 200. According to this, the positive electrode current collector 44, the laminated portion 52s, and the laser light transmissive member 200 are sandwiched between the lower plate 310 and the upper plate 320. In this manner, the positive electrode current collector 44, the laminated portion 52s, and the laser light transmissive member 200 can be fixed. Although not limited, the lamination direction of the laminated portion 52s is desirably along the vertical direction. According to this, gaps between the laminated layers of the foil in the laminated portion 52s can be easily reduced by gravity.

It should be noted that in the overlaying step, the order of overlaying the positive electrode current collector 44, the laminated portion 52s, the laser light transmissive member 200, and the jig (the lower plate 310 and the upper plate 320 in this example) is not particularly limited. In this embodiment, these members are overlaid one by one from the lower plate 310, but these members may be overlaid at a time, or members other than the jig may be overlaid and then fixed to the jig, for example.

The thickness of a portion of the laser light transmissive member 200 through which laser light L passes is, for example, 5 mm or less, desirably 4 mm or less, more desirably 3 mm or less, even more desirably 2 mm or less. The shorter the distance in which laser light L passes through the laser light transmissive member 200 is, the more diffusion of the laser light L can be suppressed, and the accuracy of laser welding can increase. The thickness of the portion of the laser light transmissive member 200 through which laser light L passes is, for example, 0.2 mm or more, desirably 0.5 mm or more, more desirably 0.8 mm or more, even more desirably 1 mm or more. If the thickness of the laser light transmissive member 200 is excessively small, strength can be insufficient. It should be noted that the thickness of the portion of the laser light transmissive member 200 through which laser light L passes can be the thickness of the laminated portions 52s in the lamination direction.

The laser light transmissive member 200 can be made of a material that allows laser light L used for laser welding to pass therethrough. The laser light transmissive member 200 can be transparent, for example. A transmittance of the laser light transmissive member 200 to a laser wavelength is, for example, 70% or more, desirably 75% or more, more desirably 80% or more. As the transmittance of the laser light transmissive member 200 to the laser wavelength increases, laser light L reaches the pre-welded portion 400 of the positive electrode current collecting foil 52 more accurately, and thus, laser welding accuracy increases. The laser wavelength only needs to be measured in accordance with a wavelength of laser light to be used, and the transmittance can be a transmittance to a laser wavelength of 900 nm to 1200 nm (e.g., 1070 nm), for example. It should be noted that the transmittance refers to a transmittance of a portion of the laser light transmissive member 200 through which laser light L passes. The transmittance to a laser wavelength herein is calculated as a proportion of energy measured by a power meter when laser light is applied to the power meter through the laser light transmissive member, supposing energy measured by the power meter when laser light is applied to the power meter for a predetermined time is 100%.

The laser light transmissive member 200 is desirably made of a material that can withstand heat generated by laser welding of the current collecting foil and the current collector. In other words, the laser light transmissive member 200 is desirably made of a material having a melting point higher than a melting point of the current collecting foil. The melting point of the laser light transmissive member 200 is, for example, 800° C. or more, can be 1200° C. or more, 1600° C. or more, 1700° C. or more, 1800° C. or more, 1900° C. or more, 2000° C. or more, 2100° C. or more, 2200° C. or more, 2300° C. or more, or 2400° C. or more.

Examples of the material for the laser light transmissive member 200 include YAG (melting point: about 1970° C.), Y₂O₃ (melting point: about 2425° C.), sapphire (melting point: about 2040° C.), and quartz glass (melting point: about 1723° C.). Among these materials, YAG and Y₂O₃ have relatively high theoretical densities. For example, in a case where the laser light transmissive member 200 is made of YAG or Y₂O₃, the density can be 4 g/cm³ or more, desirably 4.5 g/cm³ or more, more desirably 5 g/cm³ or more. According to this, in a case where the laser light transmissive member 200 is placed on the laminated portion 52s along the vertical direction, gaps between the layers of the foil in the laminated portion 52s can be easily reduced by self-weight of the laser light transmissive member 200. It should be noted that the materials that can constitute the laser light transmissive member 200 only need to be components mainly constituting the laser light transmissive member 200, and may be doped with other elements, for example. The proportion of a doped element can be, for example, 5 mol % or less, 3 mol % or less, or 1 mol % or less with respect to the entire of the doped material.

In the welding step, laser light L is applied to the pre-welded portion 400 of the laminated portion 52s, for example. At this time, the laser light L is applied such that the laser light L passes the laser light transmissive member 200 covering the pre-welded portion 400. For example, the laser light L is applied to the pre-welded portion 400 from the thickness direction of the laser light transmissive member 200. According to this, the laser light L can be applied to the pre-welded portion 400 in a state where gaps between the layers of the positive electrode current collecting foil 52 in the pre-welded portion 400 are reduced.

In application of the laser light L, the laser light transmissive member 200 is desirably pressed toward the positive electrode current collector 44. For example, the laser light transmissive member 200 can be pressed by sandwiching the positive electrode current collector 44, the laminated portion 52s, and the laser light transmissive member 200 between the lower plate 310 and the upper plate 320. According to this, gaps between the layers of the foil in the laminated portion 52s located between the laser light transmissive member 200 and the positive electrode current collector 44 are reduced, and thereby, joinability increases.

It is desirable that when the laser light transmissive member 200 is pressed toward the positive electrode current collector 44, gaps between the layers of the positive electrode current collecting foil 52 are substantially eliminated in the lamination direction of the pre-welded portion 400 of the laminated portion 52s. For example, supposing the total thickness of the laminated layers of the positive electrode current collecting foil 52 in the laminated portion 52s (thickness of the positive electrode current collecting foil 52×the number of the laminated layers of the positive electrode current collecting foil 52) is 100%, the thickness of the laminated portion 52s in the lamination direction in the pre-welded portion 400 pressed by the laser light transmissive member 200 is 110% or less, desirably 105% or less, more desirably 100% or less. According to this, melt-cutting of the current collecting foil in laser welding is suppressed, and joinability increases. It should be noted that the lower limit of the thickness of the laminated portion 52s in the lamination direction in the pre-welded portion 400 pressed by the laser light transmissive member 200 is not particularly limited, and only needs to be a thickness at which melt-cutting of the current collecting foil does not occur by pressing by the laser light transmissive member 200. Since the positive electrode current collecting foil 52 is made of a metal, the positive electrode current collecting foil 52 might be thinner than the original thickness. Thus, the lower limit of the thickness of the laminated portion 52s in the lamination direction in the pre-welded portion 400 pressed by the laser light transmissive member 200 can be, for example, 90% or more, or 95% or more.

A pressure with which the laser light transmissive member 200 is pressed toward the positive electrode current collector 44 is not particularly limited, and is, for example, 10 N to 200 N, desirably 100 N to 200 N.

Laser light L may be applied to one region of the laminated portion 52s (positive electrode current collecting foil 52), but may be applied to two or more discrete regions. That is, the number of pre-welded portions 400 of the laminated portion 52s can be one or two or more.

The pre-welded portion 400 may be a point substantially equal to an application diameter of laser light L, or may be a line. In the case where the pre-welded portion 400 is a line, laser application may be performed with laser light L or the positive electrode current collecting foil 52 being moved (scanning) in a predetermined direction. In this case, the area of the laser welded portion increases, and the positive electrode current collecting foil 52 and the positive electrode current collector 44 can be more firmly welded.

When laser light L is applied to the pre-welded portion 400, the laser light L is desirably applied from the end portion 52e of the laminated portion 52s in the pre-welded portion 400. In other words, scanning with laser light L desirably starts from the end portion 52e of the laminated portion 52s. According to this, metal vapor A easily flows to the space 500 adjacent to the end portion 52e of the laminated portion 52s, and joinability increases.

The scanning direction of laser light L is not particularly limited, and is desirably along the end portion 52e of the laminated portion 52s, for example. According to this, any of metal vapor A generated easily flows to the space 500 adjacent to the end portion 52e of the laminated portion 52s, and joinability increases.

The type of laser light L is not particularly limited, and can be appropriately selected depending on constituent materials of the current collecting foil and the current collector. Examples of the type of laser light L include YAG laser, CO₂ laser, semiconductor laser, disc laser, and fiber laser. The application diameter of the laser light L can be set from 0.5 mm to 1.0 mm, for example. Conditions of laser light L, such as application diameter, power, application time, can be set as appropriate depending on materials of the current collecting foil and the current collector for laser welding, the number of laminated layers of current collecting foil, and so forth.

As illustrated in FIG. 4, when laser light L is applied to the pre-welded portion 400 of the positive electrode current collecting foil 52, the laser welded portion 90 is thereby formed at a position (including a surrounding portion) corresponding to the pre-welded portion 400. The laser welded portion 90 is, for example, a portion in which the positive electrode current collecting foil 52 and the positive electrode current collector 44 are melted and solidified to be joined together. The laser welded portion 90 is joined from the uppermost layer to the lowermost layer of the laminated positive electrode current collecting foil 52 (i.e., not melt-cut).

As illustrated in FIG. 4, the laser welded portion 90 is located in the end portion 52c of the laminated portion 52s (end portion of the positive electrode current collecting foil 52). The laser welded portion 90 includes a tilt portion 92 that tilts outward from the uppermost surface (outer surface on a side away from the positive electrode current collector 44) of the laminated portion 52s toward the positive electrode current collector 44. The tilt portion 92 can have a structure generated when the positive electrode current collecting foil 52 of the end portion 52e of the laminated portion 52s are melted and flow toward the positive electrode current collector 44 to be solidified.

The laser welding method described above is also applicable similarly to the negative electrode 60. In this embodiment, the negative electrode current collecting foil 72 and the negative electrode current collector 64 are laser welded in a manner similar to the positive electrode 40.

In the assembly step, for example, the positive electrode current collector 44 attached to the electrode body 20 is joined to the positive electrode terminal 42 attached to the scaling member 34, and the negative electrode current collector 64 attached to the electrode body 20 is joined to the negative electrode terminal 62 attached to the sealing member 34 so that an assembly including the sealing member 34, the electrode body 20, the positive electrode terminal 42, the positive electrode current collector 44, the negative electrode terminal 62, and the negative electrode current collector 64 is obtained. A method for attaching each component may be a known method, and swaging, laser welding, ultrasonic welding, and resistance welding, for example, can be used for joint. It should be noted that the current collector and the terminal in each electrode may not be joined after the welding step, and may be previously joined before the welding step.

In the housing step, the electrode body 20 is housed in the case body 32, for example. In this example, the electrode body 20 of the assembly obtained as described above is housed in the case body 32, and the sealing member 34 is superimposed on the opening of the case body 32. At this time, an insulating film previously shaped in a bag shape or box shape may be placed between the electrode body 20 and the case body 32.

In the sealing step, portions where the sealing member 34 and the case body 32 are superimposed are welded to seal the case body 32. The welding method may be a known method, and welding may be performed by, for example, laser welding.

In the injection step, a nonaqueous electrolyte is injected by a known method from an injection port provided in the case 30. With some types of the electricity storage device, the injection step is omitted.

Thereafter, for example, under predetermined conditions, initial charge, aging treatment, and other treatments are performed, thereby producing the nonaqueous electrolyte secondary battery 100 (electricity storage device) ready for use is produced.

The technique disclosed here has been described above, but the embodiment described above is merely an example. The technique can be carried out in other various modes. The techniques described in claims include various modifications and changes of the above exemplified embodiments. For example, the embodiments described above may be partially replaced with another embodiment, and another modified embodiment may be added to the embodiments described above. It may also be deleted as appropriate if the technical features of the embodiments are not described as essential.

Variations of the technique disclosed here will be described. FIG. 5 is a schematic view of a laser welding method according to a variation. In the embodiment described above, as illustrated in FIG. 3, in the end portion 52e of the laminated portion 52s, an end portion of the laminated layers of the positive electrode current collecting foil 52 in the laminated portion 52s are aligned. However, the end portion 52e of the laminated portion 52s may have a tilt portion 52b. In the tilt portion 52b, the lowermost layer of the positive electrode current collecting foil 52 in the laminated portion 52s (the positive electrode current collecting foil 52 in contact with the positive electrode current collector 44) extends rather than the uppermost layer of the positive electrode current collecting foil 52 in the laminated portion 52s (the positive electrode current collecting foil 52 in contact with the laser light transmissive member 200). The tilt portion 52b is desirably configured such that the layers of the positive electrode current collecting foil 52 of the laminated portion 52s extend further as the layers of positive electrode current collecting foil 52 approach the positive electrode current collector 44 in the lamination direction of the laminated portion 52s, and for example, the tilt portion 52b has a stepped shape. In the tilt portion 52b, gaps (space continuous to the space 500) are formed between the extended layers of the positive electrode current collecting foil 52 and the laser light transmissive member 200, and thus, metal vapor A generated upon application of laser light L is easily diffused. According to this, a loss of a joint width of the current collecting foil and the current collector is suppressed, and joinability increases.

In the variation, laser light L is applied to a region including the tilt portion 52b of the end portion 52e of the laminated portion 52s. The direction of scanning with the laser light L is not particularly limited. For example, as illustrated in FIG. 5, the tilt portion 52b is desirably scanned with laser light L from an extended portion (end portion) of the layer of the positive electrode current collecting foil 52 in contact with the positive electrode current collector 44 to an end portion of the layer of the positive electrode current collecting foil 52 in contact with the laser light transmissive member 200 (scanning with laser light L in the direction indicated by the arrow in FIG. 5 to a position of laser light L′ indicated by broken lines). Accordingly, the metal vapor A is more easily diffused, and joinability increases. It should be noted that the structure of a portion of the tilt portion 52b not irradiated with laser light L can be kept inside the obtained nonaqueous electrolyte secondary battery.

The angle of the tilt portion 52b to the surface 44a of the positive electrode current collector 44 on which the laminated portion 52s is located is not particularly limited, and is, for example, 30° or more, desirably 45° or more, and more desirably 60° or more. If the angle of the tilt portion 52b is excessively small, the total thickness of the tilt portion 52b decreases so that melt-cutting of the positive electrode current collecting foil 52 might easily occur. The upper limit of the angle of the tilt portion 52b is not particularly limited, and can be, for example, 80° or less, 75° or less, or 70° or less. It should be noted that the angle of the tilt portion 52b refers to an angle formed by a straight line connecting an end portion of the uppermost layer of the positive electrode current collecting foil 52 to an end portion of the lowermost layer of the positive electrode current collecting foil 52 and the surface 44a of the positive electrode current collector 44 in a cross section along the direction in which the positive electrode current collecting foil 52 extends.

In the embodiment described above, the upper plate 320 is located on the region of the laser light transmissive member 200 in contact with the laminated portion 52s and is not located on a portion of the laser light transmissive member 200 extending off from the end portion 52e of the laminated portion 52s. However, the technique disclosed here is not limited to this example, the upper plate 320 may also be located on a portion of the laser light transmissive member 200 extending off from the end portion 52e of the laminated portion 52s, as well as on the region of the laser light transmissive member 200 in contact with the laminated portion 52s. For example, two or more upper plates 320 may be prepared, and an upper plate having a region through which laser light L can pass (e.g., through hole) may be prepared. According to this, gaps between the layer of the foil in the laminated portion 52s can be suitably reduced in the end portion 52e of the laminated portion 52s.

Test examples of the technique disclosed here will be described. However, the technique disclosed here is not limited to those shown in the test examples.

### Example 1

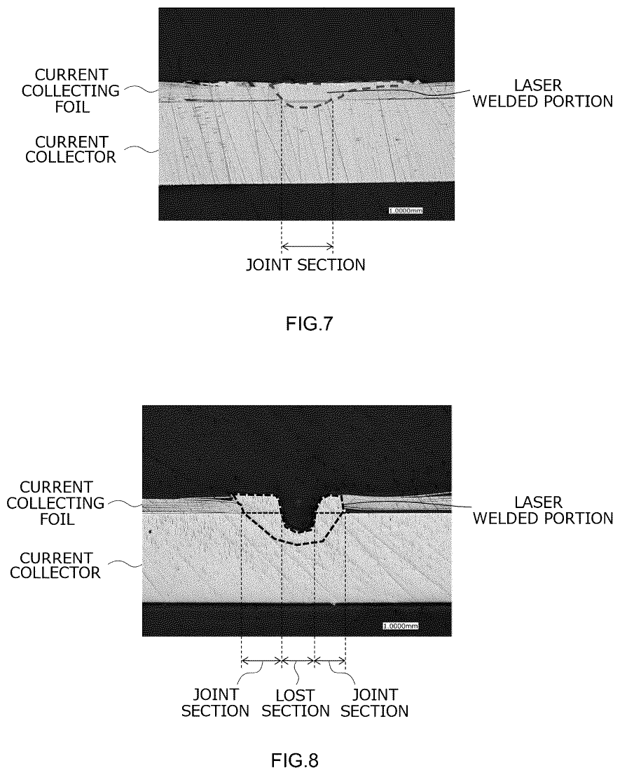

An aluminum sheet-like positive electrode current collector and a plurality of aluminum positive electrode current collecting foils were prepared. As a laser light transmissive member, plate-shaped quartz glass (melting point: 1723° C., transmittance to laser wavelength: 82%) having a thickness of 1 mm was prepared. A jig with the configuration illustrated in FIG. 3 was prepared. In a manner similar to FIG. 3, the positive electrode current collector, the positive electrode current collecting foils, and the laser light transmissive member are overlaid and set on the jig, and the laser light transmissive member was pressed toward the positive electrode current collector. With this state kept, YAG laser (power: 2000 W, application time: 0.005 sec., laser input heat quantity: 10 J) was applied to end portions of the positive electrode current collecting foils through the laser light transmissive member in the thickness direction of the laser light transmissive member, and scanning with YAG laser was performed along the end portions of the positive electrode current collecting foils. In this manner, the positive electrode current collecting foils and the positive electrode current collector were laser welded. It should be noted that FIG. 6 shows a cross-sectional SEM image near the laser welded portion. In FIG. 6, the portion surrounded by the bold broken line is a laser welded portion (the same holds for FIGS. 7 and 8).

### Example 2

The same positive electrode current collector, positive electrode current collecting foils, and laser light transmissive member as those of Example 1 were prepared. The positive electrode current collecting foils were laminated such that end portions thereof form a stepped tilt portion, and in a manner similar to FIG. 5, the positive electrode current collector, the positive electrode current collecting foils, and the laser light transmissive member were overlaid and set on a jig. Scanning with YAG laser in conditions similar to those of the Example 1 was performed from the lower end of the tilt portion of the positive electrode current collecting foils (end portion of the positive electrode current collecting foil in contact with the positive electrode current collector) to the upper end (end portion of the positive electrode current collecting foil in contact with the laser light transmissive member), and laser welding was performed. FIG. 7 shows a cross-sectional SEM image near the laser welded portion in a direction perpendicular to a direction in which the tilt portion of the positive electrode current collecting foils 52 extends.

### Comparative Example

Laser welding was performed in the same manner as in the Example 1 except for changing a portion exposed to YAG laser from the end portions of the positive electrode current collecting foils to center portions of the positive electrode current collecting foils (region not including end portions). FIG. 8 shows a cross-sectional SEM image near the laser welded portion.

As shown in FIG. 8, in a comparative example, although the positive electrode current collecting foils are not melt-cut, but a recess was formed on the laser welded portion from the positive electrode current collecting foils toward the positive electrode current collector. This recess was formed beyond the surface of the positive electrode current collector on which the positive electrode current collecting foils were placed, and a portion of a joint section between the positive electrode current collecting foils and the positive electrode current collector was partially lost. On the other hand, as shown in FIGS. 6 and 7, in Example 1 and Example 2, no recess was formed on the laser welded portion unlike the comparative example, and the joint section between the positive electrode current collecting foils and the positive electrode current collector was not lost.

As described above, the following items provide specific aspects of the technique disclosed here.

### Item 1:

A method for producing an electricity storage device including a positive electrode including a plurality of laminated layers of positive electrode current collecting foil and a positive electrode current collector connected to the laminated layers of the positive electrode current collecting foil, and
a negative electrode including a plurality of laminated layers of negative electrode current collecting foil and a negative electrode current collector connected to the laminated layers of the negative electrode current collecting foil, the method including:
overlaying the laminated layers of the current collecting foil on the current collector in at least one of the positive electrode or the negative electrode;
placing a laser light transmissive member on the layers of the current collecting foil overlying the current collector such that a portion of the laser light transmissive member extends off from an end portion of the layers of the current collecting foil overlying the current collector; and
applying laser light to a region including the end portion of the layers of the current collecting foil overlying the current collector through the laser light transmissive member to perform welding of the layers of the current collecting foil overlying the current collector and the current collector.

### Item 2:

The method according to Item 1, wherein the welding is performed while the laser light transmissive member is pressed toward the current collector.

### Item 3:

The method according to Item 1 or 2, wherein the end portion of the layers of the current collecting foil overlying the current collector include a tilt portion in which the layer of the current collecting foil in contact with the current collector extends further than the layer of the current collecting foil in contact with the laser light transmissive member.

### Item 4:

The method according to Item 3, including performing the welding while scanning with the laser light from an extending portion of the layer of the current collecting foil in contact with the current collector in the tilt portion to a portion of the tilt portion in contact with the laser light transmissive member.

### Item 5:

The method according to any one of Items 1 to 4, wherein a transmittance of a test piece of the laser light transmissive member with a thickness of 2 mm to a wavelength of the laser light in a thickness direction of the test piece is 80% or more.

### Item 6:

The method according to any one of Items 1 to 5, wherein a thickness of a portion of the laser light transmissive member through which the laser light passes is 5 mm or less.

### Item 7:

An electricity storage device including:
a positive electrode including a plurality of laminated layers of positive electrode current collecting foil and a positive electrode current collector connected to the laminated layers of the positive electrode current collecting foil; and
a negative electrode including a plurality of laminated layers of negative electrode current collecting foil and a negative electrode current collector connected to the laminated layers of the negative electrode current collecting foil, wherein
at least one of the positive electrode or the negative electrode includes a laser welded portion in which the plurality of the layers of the current collecting foil is joined to the current collector in a state where the plurality of the layers of the current collecting foil are laminated, and
the laser welded portion is located in an end portion of the layers of the current collecting foil.

### Item 8:

The electricity storage device according to Item 7, wherein
the current collector and the laminated layers of the current collecting foil are overlaid in a lamination direction in which the layers of the current collecting foil are laminated, and
the end portion of the laminated layers of the current collecting foil in which the laser welded portion is located includes a tilt portion in which the layers of the current collecting foil extend further as the layers of the current collecting foil approach the current collector.

What is claimed is:

1. A method for producing an electricity storage device including a positive electrode including a plurality of laminated layers of positive electrode current collecting foil and a positive electrode current collector connected to the laminated layers of the positive electrode current collecting foil, and
a negative electrode including a plurality of laminated layers of negative electrode current collecting foil and a negative electrode current collector connected to the laminated layers of the negative electrode current collecting foil, the method comprising:
overlaying the laminated layers of the current collecting foil on the current collector in at least one of the positive electrode or the negative electrode;
placing a laser light transmissive member on the layers of the current collecting foil overlying the current collector such that a portion of the laser light transmissive member extends off from an end portion of the layers of the current collecting foil overlying the current collector; and
applying laser light to a region including the end portion of the layers of the current collecting foil overlying the current collector through the laser light transmissive member to perform welding of the layers of the current collecting foil overlying the current collector and the current collector.

2. The method according to claim 1, wherein the welding is performed while the laser light transmissive member is pressed toward the current collector.

3. The method according to claim 1, wherein the end portion of the layers of the current collecting foil overlying the current collector include a tilt portion in which the layer of the current collecting foil in contact with the current collector extends further than the layer of the current collecting foil in contact with the laser light transmissive member.

4. The method according to claim 3, comprising performing the welding while scanning with the laser light from an extending portion of the layer of the current collecting foil in contact with the current collector in the tilt portion to a portion of the tilt portion in contact with the laser light transmissive member.

5. The method according to claim 1, wherein a transmittance of a test piece of the laser light transmissive member with a thickness of 2 mm to a wavelength of the laser light in a thickness direction of the test piece is 80% or more.

6. The method according to claim 1, wherein a thickness of a portion of the laser light transmissive member through which the laser light passes is 5 mm or less.

7. An electricity storage device comprising:
a positive electrode including a plurality of laminated layers of positive electrode current collecting foil and a positive electrode current collector connected to the laminated layers of the positive electrode current collecting foil; and
a negative electrode including a plurality of laminated layers of negative electrode current collecting foil and a negative electrode current collector connected to the laminated layers of the negative electrode current collecting foil, wherein
at least one of the positive electrode or the negative electrode includes a laser welded portion in which the plurality of the layers of the current collecting foil is joined to the current collector in a state where the plurality of the layers of the current collecting foil are laminated, and
the laser welded portion is located in an end portion of the layers of the current collecting foil.

8. The electricity storage device according to claim 7, wherein
the current collector and the laminated layers of the current collecting foil are overlaid in a lamination direction in which the layers of the current collecting foil are laminated, and
the end portion of the laminated layers of the current collecting foil in which the laser welded portion is located include a tilt portion in which the layers of the current collecting foil extend further as the layers of the current collecting foil approach the current collector.
